(19) United States
(12) Patent Application Publication
(10) Pub. No.: US 2014/0227402 A1
(43) Pub. Date: Aug. 14, 2014

(54) FOOD HOLDING CABINET AND METHOD FOR HOLDING HOT FOOD

(71) Applicants: Kim Huei Tan, Singapore (SG); Sharifah Nadiah Alkadri, Singapore (SG)

(72) Inventors: Kim Huei Tan, Singapore (SG); Sharifah Nadiah Alkadri, Singapore (SG)

(21) Appl. No.: 14/346,135

(22) PCT Filed: Nov. 23, 2011
(86) PCT No.: PCT/US11/62108

§ 371 Date: Mar. 20, 2014

Related U.S. Application Data
(60) Provisional application No. 61/537,529, filed on Sep. 21, 2011.

(51) Int. Cl. A47J 36/24; A23L 1/01

(52) U.S. Cl. CPC A47J 36/2488; A47J 36/2494; A23L 1/0128
USPC 426/231; 99/483

(57) ABSTRACT

A food holding cabinet for holding and keeping hot food safe and fresh at a desired temperature until ready to be served. Radiant heaters disposed in food compartment walls supply radiant heat to the interior of the food holding compartment. The radiant heat is transferred from the radiant heaters via metallic heat sink plates. The radiant heat is supplied from two vertical walls and one horizontal wall to provide a uniformity of heat distribution across all tray levels.

### CROSS-REFERENCED APPLICATIONS

This application is a National Stage Application of PCT/US2011/062108, filed on Nov. 23, 2011, which claims priority to US Provisional Application No. 61/537529, filed on Sep. 21, 2011, both of which are incorporated in their entireties by reference thereto.

### FIELD OF THE DISCLOSURE

This disclosure relates to a food holding cabinet and method for holding and keeping hot pre-cooked food safe and fresh at a desired temperature until it is ready to be served.

### BACKGROUND OF THE DISCLOSURE

Food holding cabinets are used to keep pre-cooked food hot. Some known food holding cabinets have been characterized with uneven distribution of heat transferred into the food holding compartment. A challenge is to retain moisture in the food while keeping the food warm. Some known food holding cabinets use a hot air blowing method. Moisture injection is sometimes used to maintain a proper humidity in the food compartment. These methods require adding a fan box and/or moisture generating capability. This adds manufacturing expense, extra size, extra maintenance and extra power consumption.

There is a need for a food holding cabinet and method that provides uniform heat distribution at all levels within the food holding compartment.

There is also a need for a food holding cabinet and method that retains moisture in the food and the flavor of the original taste without using a moving hot air stream with moisture injection.

### SUMMARY OF THE DISCLOSURE

A holding cabinet for holding hot food according to one embodiment of the present disclosure comprises a plurality of walls that define a compartment having a holding structure for holding hot food. One or more of the walls comprises an internal panel and an external panel. A radiant heating element is disposed in a space between the internal panel and the external panel. A heat sink plate is disposed in the space in contact with the internal panel such that radiant heat is transferred from the radiant heating element via the heat sink plate and the internal panel into an interior of the compartment.

In another embodiment of a holding cabinet for holding hot food according to the present disclosure, the heat sink plate is selected from the group consisting of: aluminum, an alloy of aluminum and other metal.

In another embodiment of a holding cabinet for holding hot food according to the present disclosure, the radiant heating element comprises at least one silicon heating pad.

In another embodiment of a holding cabinet for holding hot food according to the present disclosure, a plate is disposed in the space that presses the radiant heating element against the heat sink plate.

In another embodiment of a holding cabinet for holding hot food according to the present disclosure, thermal insulation is disposed between the plate and the radiant heating element.

In another embodiment of a holding cabinet for holding hot food according to the present disclosure, the one or more walls is selected from the group consisting of: one vertical wall, two vertical walls, one vertical wall and one horizontal wall, two vertical walls and one horizontal wall, and two vertical walls and two horizontal walls.

In another embodiment of a holding cabinet for holding hot food according to the present disclosure, the one or more walls provide radiant heat flow horizontally and vertically within the compartment.

In another embodiment of a holding cabinet for holding hot food according to the present disclosure, a door is provided for the compartment and an adjustable vent to ambient is disposed in the door to control uniformity of heat distribution within the compartment.

A method according to the present disclosure keeps pre-heated food warm in a closed compartment of a holding cabinet, by:

providing radiant heat vertically and horizontally to the compartment; and

controlling uniformity of the radiant heat within the compartment.

In another embodiment of the method of the present disclosure, the providing step comprises: transferring the radiant heat from one or more radiant heating elements via one or more heat sink plates to the compartment.

In another embodiment of the method of the present disclosure, at least one of the radiant heating elements is flush against at least one of the heat sink plates.

In another embodiment of the method of the present disclosure, the controlling step comprises: adjusting a vent to ambient disposed on the compartment.

In another embodiment of the method of the present disclosure, the vent is disposed in a door of the compartment.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a perspective view of a food holding cabinet according to the present disclosure;

FIG. 2 is a front view of the food holding cabinet of FIG. 1 with doors removed;

FIG. 3 is a cross-sectional view taken along line 3 of FIG. 2;

FIG. 4 is an enlarged view of detail A of FIG. 3; and

FIG. 5 is an exploded perspective view of a sidewall of the holding cabinet of FIG. 1.

### DESCRIPTION OF THE PREFERRED EMBODIMENT

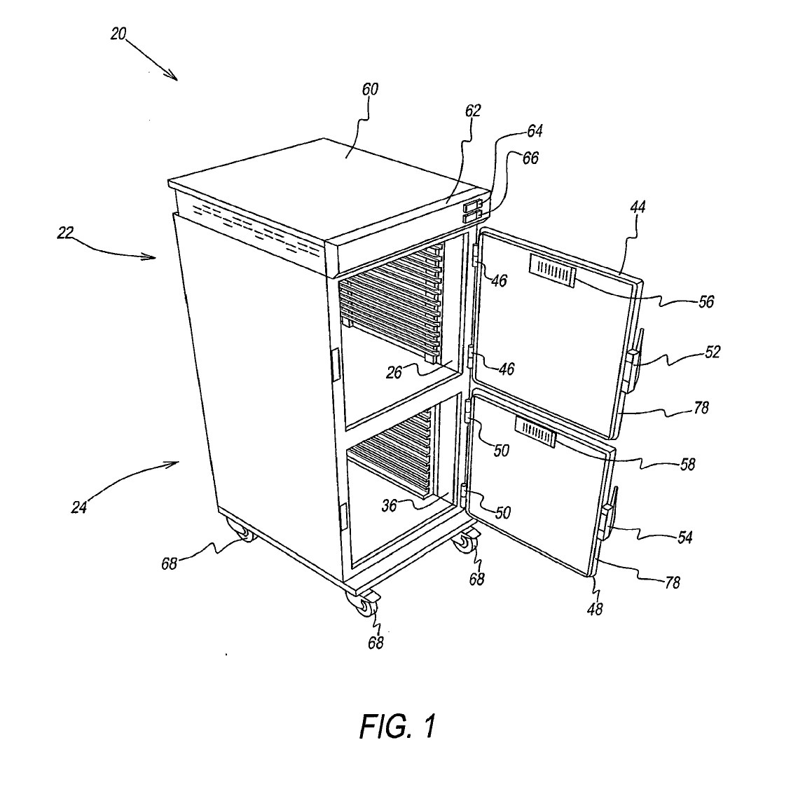

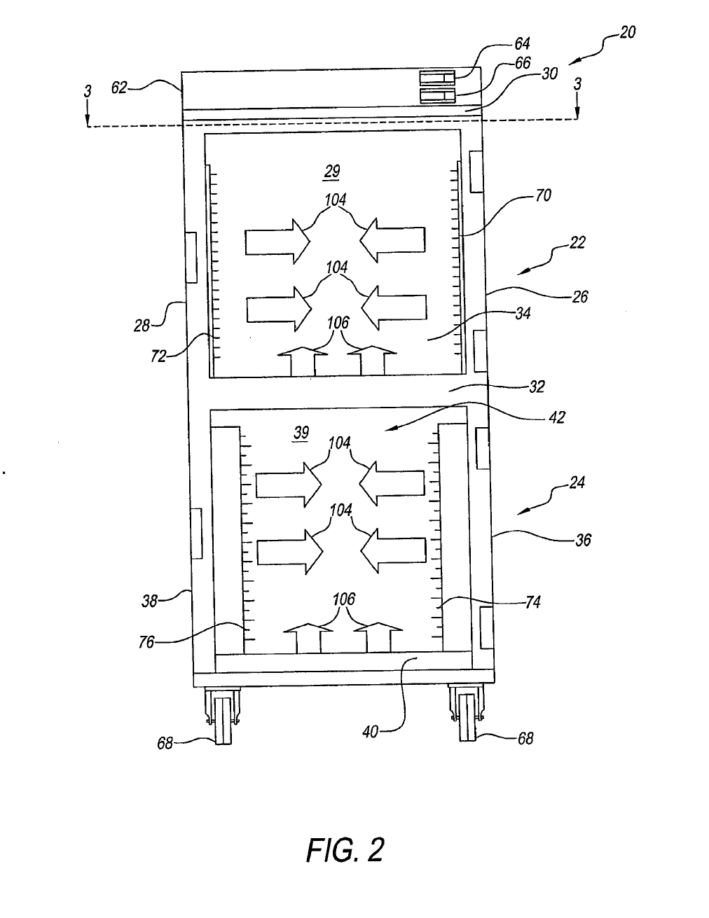

Referring to FIGS. 1 and 2, a food holding cabinet 20 according to the present disclosure comprises an upper section 22 and a lower section 24. Upper section 22 comprises sidewalls 26 and 28, a back wall 29, a top wall 30 and a wall 32, which define an upper compartment 34. Lower section 24 comprises sidewalls 36 and 38, a back wall 39, a bottom wall 40 and wall 32, which define a lower compartment 42. Wall 32 serves as a bottom wall for upper compartment 34 and as a top wall for lower compartment 42.

An upper door 44 is attached to sidewall 26 of upper compartment 34 with hinges 46. A lower door 48 is attached to sidewall 36 of lower compartment 42 with hinges 50. Upper and lower doors 44 and 48 have handles 52 and 54, respectively. Gaskets 78 are mounted on upper and lower doors 44 and 48. Upper and lower doors 44 and 48 also comprise air pressure adjusters 56 and 58, respectively. Air pressure adjusters 56 and 58, for example, may be manually operated slider vents that vent air within upper and lower compartments 34 and 42 to ambient.

Food holding cabinet 20 further comprises a control section 60 mounted above upper compartment 34. Control section 60 includes a control panel 62 that has temperature adjusting knobs 64 and 66 for upper and lower compartments 34 and 42, respectively. Control section 60 further includes various control items, such as connections to temperature sensors (not shown) disposed in upper and lower compartments 34 and 42 to allow temperature adjustments, to a power source (not shown), e.g., a conventional ac electrical power source and the like.

A plurality of caster wheels 68 is fastened to a bottom of food holding cabinet 20. The caster wheels 68 fastened to the back are rigid without brakes and the caster wheels 68 fastened to the front are swivel with brakes.

Tray holding racks 70 and 72 are mounted to interior surfaces of side walls 26 and 28, respectively, of upper compartment 34 and tray holding racks 74 and 76 are mounted to interior surfaces of sidewalls 36 and 38, respectively, of lower compartment 42. Upper tray racks 70 and 72 are smaller in depth than lower tray tracks 74 and 76 in order to handle larger tray sizes (for example, 20.9 inches by 25.6 inches). On the other hand, lower tray tracks 74 and 76 handle smaller trays (for example, 18 inches by 25.6 inches). It will be appreciated that in some embodiments tray racks 70 and 72 can be sized for tray sizes other than the above examples or even sized equally for same sized trays.

Sidewalls 26, 28, 36 and 38, wall 32 and bottom wall 40 are substantially identical to one another. Because of this, only sidewall 28 will be described in detail.

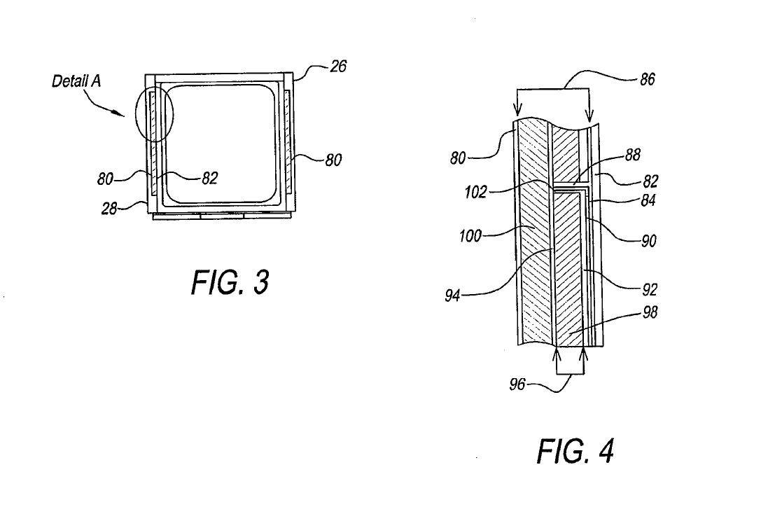

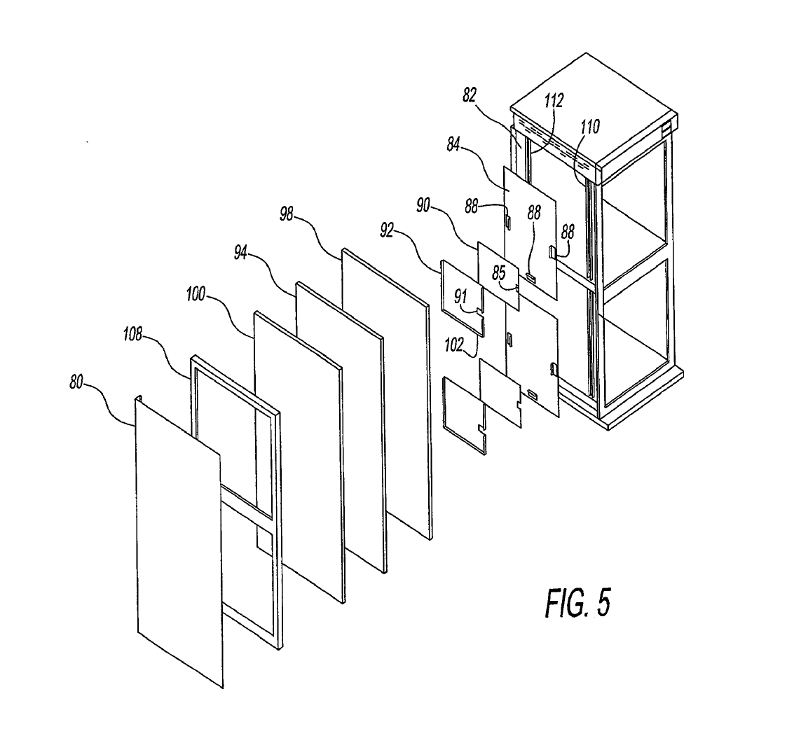

Referring to FIGS. 3-5, sidewall 28 comprises an external panel 80 and an internal panel 82. A pair of rails 110 and 112 (shown in FIG. 5) are mounted near opposite vertical edges of an interior surface of internal panel 82. A heat sink plate 84 is disposed between rails 110 and 112 on the interior surface of internal panel 82 in a space 86 between external panel 80 and internal panel 82. Preferably, heat sink plate 84 has a surface that is mounted flush to the interior surface of internal panel 82. A heating element 90 is disposed in space 86 and has a surface flush to an opposite surface of heat sink plate 84. A plate 92 is disposed in space 86 and is mounted flush to an opposite surface of heating element 90.

An insulation layer 98, a plate cover 94, an insulation layer 100, a frame 108 and external panel 80 extend vertically of sidewalls 28 and 38. Plate cover 94 is disposed in space 86 parallel to external panel 80 and internal panel 82 to form a region 96 in each sidewall 28 and 38 between plate 92 and plate cover 94. Three bosses 88 extend from heat sink plate 84 in region 96 to physical contact with plate cover 94. Bosses 88 are positioned to hold heating element 90 in a desired location on heat sink plate 84. In the illustrated embodiment, one boss 88 is located near a bottom edge of heat sink plate 84 and the other two bosses 88 are located near opposite vertical edges of heat sink plate 84.

A slot 85 is positioned adjacent a vertical edge of heating element 90 in a mating relationship with the boss 88 adjacent a vertical edge of heat sink plate 84. Plate 92 also has a notch 91 that is positioned on a vertical edge so as to be in registry with slot 85 of heating element 90 and the boss 88 adjacent a vertical edge of plate 92. A frame 102 extends from a bottom edge and the vertical edges of plate 92 in region 96 to physical contact with plate cover 94. A thermal insulation layer 98 is disposed in region 96 in sufficient amount to press or clamp plate 92, heating element 90, heat sink plate 84 and internal panel 82 together in the aforementioned flush relationships. An insulation layer 100 is disposed in space 86 between external panel 80 and plate cover 94 in sufficient amount to press or clamp plate cover 94 to bosses 88 of heat sink plate 84 and a frame 102 of plate 92.

Preferably, heating element 90 and heat sink plate 84 cover a substantial portion of internal panel 82. Heating element 90 comprises a radiant heating element that provides radiant heat in a medium wavelength range of 5 to 8 micrometers. One example of a preferred radiant heating element 90 is a silicon heater pad, available from Alden Works as model no. R30-653 & R30-654. Heat sink plate 84 is preferably a metal plate, for example, aluminum or other metal that is capable of transferring radiant heat from heating element 90 into upper compartment 34.

External panel 80, internal panel 82 and frame 108 are preferably a suitable metal, such as stainless steel. Plate 92 and plate cover 94 are preferably a galvanized metal. Insulation layer 98 is preferably a thermal insulation, such as ceramic wool insulation. Insulation layer 100 is preferably a thermal insulation, such as rock wool insulation.

When connected to a source of electrical energy, heating element 90 emits radiant heat, which is transferred via heat sink plate 84 into upper compartment 34 or lower compartment 42. In the preferred embodiment, radiant heat is supplied both horizontally and vertically in upper and/or lower compartments 34 and 42. Preferably, the radiant heat is supplied from both sidewalls 26 and 28 and bottom wall 32 in upper compartment 34. In lower compartment 42, the radiant heat is supplied from both sidewalls 36 and 38 and bottom wall 40. For this embodiment, the radiant heat flow is as shown in FIG. 2 by horizontal arrows 104 and vertical arrows 106. In this embodiment, the hot air is distributed uniformly across all tray levels within upper compartment 34 and lower compartment 42. This distribution is assisted by air pressure adjusters 56 and 58, which vent hot air to ambient as well as control the air pressure within the upper and lower compartments 34 and 42.

In other embodiments, heat can be supplied from one vertical wall, two vertical walls, one vertical wall and one horizontal wall, and two vertical walls and two horizontal walls.

Temperature adjuster knobs 64 and 66 are manually operable to set the temperature in upper and lower compartments 34 and 42. Upper and lower temperature sensors (not shown) are located in upper compartment 34 and lower compartment 42, respectively, and provide a temperature signal to control section 60. A control unit (not shown) in control section 60 responds to the temperature signal to operate the heating elements 90 to attain and maintain the set temperature within upper and lower compartments 34 and 42. Separate temperature adjuster knobs 64 and 66 allow different temperatures to be set in upper and lower compartments 34 and 42, so as to accommodate different food types in food holding cabinet 20.

The present disclosure having been thus described with particular reference to the preferred forms thereof, it will be obvious that various changes and modifications may be made therein without departing from the spirit and scope of the present disclosure as defined in the appended claims.

What is claimed is:

1. A holding cabinet for holding hot food comprising:
a plurality of walls that define a compartment having a holding structure for holding said hot food; and
one or more of said walls each comprising:
an internal panel and an external panel;
a radiant heating element disposed in a space between said internal panel and said external panel, and
a heat sink plate disposed in said space in contact with said internal panel such that radiant heat is transferred from said radiant heating element via said heat sink plate and said internal panel into an interior of said compartment.

2. The holding cabinet of claim 1, wherein said heat sink plate is selected from the group consisting of: aluminum, an alloy of aluminum and other metal.

3. The holding cabinet of claim 1, wherein said radiant heating element comprises at least one silicon heating pad.

4. The holding cabinet of claim 1, further comprising a plate disposed in said space that presses said radiant heating element against said heat sink plate.

5. The holding cabinet of claim 4, wherein thermal insulation is disposed between said plate and said radiant heating element.

6. The holding cabinet of claim 1, wherein said one or more walls is selected from the group consisting of: one vertical wall, two vertical walls, one vertical wall and one horizontal wall, two vertical walls and one horizontal wall, and two vertical walls and two horizontal walls.

7. The holding cabinet of claim 1, wherein said one or more walls provide radiant heat flow horizontally and vertically within said compartment.

8. The holding cabinet of claim 1, further comprising a door for said compartment and an adjustable vent to ambient disposed in said door to control uniformity of heat distribution within said compartment.

9. A method of keeping pre-heated food warm in a closed compartment of a holding cabinet, said method comprising:
providing radiant heat vertically and horizontally to said compartment; and
controlling uniformity of said radiant heat within said compartment.

10. The method of claim 9, wherein said providing step comprises:
transferring said radiant heat from one or more radiant heating elements via one or more heat sink plates to said compartment.

11. The method of claim 10, wherein at least one of said radiant heating elements is flush against at least one of said heat sink plates.

12. The method of claim 9, wherein said controlling step comprises:
adjusting a vent to ambient disposed on said compartment.

13. The method of claim 12, wherein said vent is disposed in a door of said compartment.
